(19) United States
(12) Patent Application Publication
(10) Pub. No.: US 2014/0268067 A1
(43) Pub. Date: Sep. 18, 2014

(54) ILLUMINATION DEVICE AND PROJECTOR

(71) Applicant: SEIKO EPSON CORPORATION, Tokyo (JP)

(72) Inventors: Koichi AKIYAMA, Matsumoto-Shi (JP); Akihiro KASHIWAGI, Shiojiri-Shi (JP)

(73) Assignee: SEIKO EPSON CORPORATION, Tokyo (JP)

(21) Appl. No.: 14/200,929

(22) Filed: Mar. 7, 2014

(30) Foreign Application Priority Data
Mar. 15, 2013 (JP) 2013-053728

(51) Int. Cl. H04N 9/31; G02B 5/32; G02B 27/10

(52) U.S. Cl. CPC H04N 9/3105; G02B 27/1066; G02B 5/32
USPC 353/31; 359/567; 359/15; 353/30

(57) ABSTRACT

A illumination device includes a light source, a diffractive optical element on which light emitted from the light source is made incident, and a superimposing optical system on which diffracted light emitted from the diffractive optical element is made incident. A direction of a principal ray in the center of the diffracted light coincides with an optical axis of the superimposing optical system. Consequently, it is possible to reduce an aberration due to the superimposing optical system and to emit illumination light having a more uniform illuminance distribution.

### BACKGROUND

1. Technical Field

The present invention relates to a illumination device and a projector.

2. Related Art

There has been widely known a projector that illuminates a light modulating device with illumination light emitted from a illumination device, magnifies image light modulated and emitted by the light modulating device, and projects the magnified image light on a screen using a projection optical system.

As a light source of the illumination device included in the projector, a laser light source such as a semiconductor laser (LD), with which high-luminance and high-power light can be obtained, attracts attention. Compared with a metal halide lamp, a halogen lamp, and the like in the past, the laser light source has advantages that the laser light source can be reduced in size, is excellent in color reproducibility, can be lit instantaneously, and has long life.

The related art is described in, for example, JP-A-11-64789 and JP-A-2000-162548.

In order to perform video display excellent in display quality in the projector, it is necessary to improve uniformity of an illuminance distribution of illumination light with which the light modulating device serving as an illumination target is irradiated.

### SUMMARY

An advantage of some aspects of the invention is to provide a illumination device that can emit illumination light having a more uniform illuminance distribution and a projector including the illumination device.

An aspect of the invention is directed to a illumination device including: a light source; a diffractive optical element on which light emitted from the light source is incident; and a superimposing optical system on which diffracted light emitted from the diffractive optical element is incident. A direction of a principal ray in the center of the diffracted light coincides with an optical axis of the superimposing optical system.

With the configuration of the illumination device, the direction of the principal ray in the center of the diffracted light coincides with the optical axis of the superimposing optical system. Therefore, it is possible to emit illumination light having a more uniform illuminance distribution while reducing an aberration due to the superimposing optical system.

It is preferable that the light emitted from the light source is perpendicularly incident on a light incident surface of the diffractive optical element, and the direction of the principal ray in the center of the diffracted light is tilted with respect to an optical axis of the light emitted from the light source.

With this configuration, it is easy to perform diffractive optical design of the diffractive optical element. Further, it is possible to efficiently make the diffracted light emitted from the diffractive optical element enter the superimposing optical system.

It is preferable that the direction of the principal ray in the center of the diffracted light is tilted at an angle of 5 to 20° with respect to the optical axis of the light emitted from the light source.

With this configuration, it is possible to emit illumination light having a more uniform illuminance distribution while reducing an aberration due to the superimposing optical system.

It is preferable that the superimposing optical system is configured by a lens group of at least two lenses, the diffractive optical element is arranged at a combined front focal position of the lens group, and an illumination target is arranged at a combined rear focal position of the lens group.

With this configuration, it is possible to efficiently make light superimposed by the superimposing optical system incident on the illumination target.

It is preferable that the diffracted light has a luminous intensity distribution of a rectangular shape as a whole and that an aspect ratio of the luminous intensity distribution is equal to an aspect ratio of the illumination target.

With this configuration, it is possible to efficiently make illumination light formed in a rectangular shape as a whole incident on the illumination target formed in a rectangular shape.

It is preferable that the light source and the diffractive optical element are arranged such that, when the principal ray in the center of the diffracted light is set to coincide with the horizontal direction, the light emitted from the light source is incident on the diffractive optical element from upward to downward.

With this configuration, it is possible to suitably use the illumination device as a illumination device for a projector.

A computer generated hologram can be used as the diffractive optical element.

With this configuration, it is possible to generate diffracted light with which diffraction efficiency of first order diffracted light is maximized and to generate diffracted light having a more uniform illuminance distribution.

A semiconductor laser can be used as the light source.

With this configuration, it is possible to obtain high-luminance and high-power light and reduce the size of the light source.

An array light source in which a plurality of the semiconductor lasers are arrayed can be used as the light source.

With this configuration, it is possible to obtain higher-luminance and higher-power light using the array light source in which the plurality of semiconductor lasers are arrayed.

It is preferable that a collimator optical system configured to convert the light emitted from the light source into parallel light is provided.

With this configuration, it is possible to convert the light emitted from the light source into parallel light and make the parallel light incident on the diffractive optical element.

It is preferable that an afocal optical system is arranged between the light source and the diffractive optical element.

With this configuration, it is possible to efficiently make the light emitted from the light source incident on the diffractive optical element while adjusting the size (the spot diameter) of the light.

Another aspect of the invention is directed to a projector including: a illumination device configured to emit illumination light; a light modulating device configured to form image light obtained by modulating the illumination light according to image information; and a projection optical system configured to project the image light. The illumination device described in the aspect explained above is used as the illumination device.

With the configuration of the projector, it is possible to perform display excellent in image quality and further reduce the size of the projector.

The light emitted from the light source may be linearly polarized light. A liquid crystal panel may be used as the light modulating device.

With the configuration, it is possible to make the illumination light emitted from the illumination device incident on the liquid crystal panel without using a polarization conversion element or the like. Therefore, it is possible to further reduce the size of the projector while reducing the number of components.

A plurality of the illumination devices and a plurality of the light modulating devices may be arranged for respective illumination lights having different wavelength regions. The projector may further include a combining optical system configured to combine image lights modulated for the respective illumination lights having the different wavelength regions.

With this configuration, it is possible to display a color video (image) using the image lights modulated for the respective illumination lights having the different wavelength regions.

### BRIEF DESCRIPTION OF THE DRAWINGS

The invention will be described with reference to the accompanying drawings, wherein like numbers reference like elements.

FIG. 1 is a plan view showing the schematic configuration of a projector.

FIG. 2 is a plan view showing the schematic configuration of a illumination device.

FIGS. 3A to 3C are optical path diagrams for explaining the arrangement of a diffractive optical element, a superimposing optical system, and a light modulating device.

### DESCRIPTION OF EXEMPLARY EMBODIMENTS

An embodiment of the invention is explained in detail below with reference to the drawings.

Note that, in the drawings used in the following explanation, characteristic portions are sometimes enlarged and shown for convenience to clearly show characteristics. Dimension ratios and the like of components are not always the same as actual ones.

### Projector

First, an example of a projector 100 shown in FIG. 1 is explained.

FIG. 1 is a plan view showing the schematic configuration of the projector 100.

The projector 100 is a projection type image display apparatus that displays a color video (image) on a screen (a projection surface) SCR. As a light source of a illumination device included in the projector 100, a laser light source such as a semiconductor laser (LD), with which high-luminance and high-power light can be obtained, is used.

Specifically, the projector 100 generally includes illumination devices 101R, 1016, and 101B configured to respectively emit laser lights (illumination lights) corresponding to colors of red (R), green (G), and blue (B), light modulating devices 102R, 102G, and 102B configured to respectively modulate, according to an image signal, the laser lights emitted from the illumination devices 101R, 101G, and 101B and form image lights corresponding to the colors, a combining optical system 103 configured to combine the image lights emitted from the light modulating devices 102R, 102G, and 102B, and a projection optical system 104 configured to project image light emitted from the combining optical system 103 toward the screen SCR.

The illumination devices 101R, 101G, and 101B basically have the same configuration except that semiconductor lasers corresponding to the colors of red (R), green (G), and blue (B) are used as light sources. The illumination devices 101R, 101G, and 101B emit illumination lights modulated to have a uniform illuminance distribution toward the light modulating devices 102R, 102G, and 102B.

The light modulating devices 102R, 102G, and 102B are configured by liquid crystal light valves (liquid crystal panels). The light modulating devices 102R, 102G, and 102B respectively form image lights obtained by modulating illumination lights corresponding to the colors according to image information. Note that sheet polarizers (not shown in the figure) are arranged on incident sides and emission sides of the light modulating devices 102R, 102G, and 102B to allow only linearly polarized lights in specific directions to pass.

The combining optical system 103 is configured by a cross dichroic prism. The image lights emitted from the light modulating devices 102R, 102G, and 102B are incident on the combining optical system 103. The combining optical system 103 combines the image lights corresponding to the colors and emits the combined image light toward the projection optical system 104.

The projection optical system 104 is configured by a projection lens group. The projection optical system 104 magnifies the image light combined by the combining optical system 103 and projects the magnified image light toward the screen SCR. Consequently, a magnified color video (image) is displayed on the screen SCR.

### Illumination Device

The specific configuration of the illumination devices 101R, 101G, and 101B is explained.

Note that, as explained above, the illumination devices 101R, 101G, and 101B basically have the same configuration except that semiconductor lasers corresponding to the colors of red (R), green (G), and blue (B) are used as light sources. Therefore, in the following explanation, the illumination device 101R is explained. Note that FIG. 2 is a plan view showing the schematic configuration of the illumination device 101R.

The illumination device 101R generally includes, as shown in FIG. 2, an array light source 2 in which a plurality of semiconductor lasers 2a are arrayed, a collimator optical system 3 on which lights L1 emitted from the semiconductor lasers 2a are incident, an afocal optical system 4 on which the lights L1 converted in to parallel lights by the collimator optical system 3 are incident, a diffractive optical element 5 on which the lights L1, the size (the spot diameter) of which is adjusted by the afocal optical system 4, are incident, and a superimposing optical system 6 on which lights (diffracted lights) L2 diffracted by the diffractive optical element 5 are incident. Lights L3 superimposed by the superimposing optical system 6 enter the light modulating device 102R as illumination light.

The array light source 2 is configured by arranging the plurality of semiconductor lasers 2a in an array shape in a surface orthogonal to an optical axis ax1. The laser lights L1 emitted from the semiconductor lasers 2a are linearly polarized coherent lights. The laser lights L1 are emitted in parallel to one another.

The collimator optical system 3 is configured by a plurality of collimator lenses 3a arranged in an array shape to correspond to the semiconductor lasers 2a. The laser lights L1 converted into parallel lights by the collimator lenses 3a are incident on the afocal optical system 4.

The afocal optical system 4 is configured by lenses 4a and 4b. The lights L1, the size (the spot diameter) of which is adjusted by the afocal optical system 4, are incident on the diffractive optical element 5.

The diffractive optical element 5 is configured by a computer generated hologram (CGH). The diffractive optical element 5 is designed such that diffraction efficiency of first order diffracted light is maximized.

Note that, as the first order diffracted light, there are +first order diffracted light and −first order diffracted light. The diffractive optical element 5 is designed such that diffraction efficiency of one of the first order diffracted lights is maximized. When the CGH is used, it is possible to set the diffraction efficiency of the first order diffracted light to 90% or higher (ideally, 1000).

A plurality of the laser lights L1 emitted from the semiconductor lasers 2a of the array light source 2 are incident on the diffractive optical element 5. Therefore, a plurality of first order diffracted lights is emitted from the diffractive optical element 5. The number of the first order diffracted lights corresponds to the number of the plurality of laser lights L1. Principal rays of the first order diffracted lights are parallel to one another. Therefore, in the invention, unless specifically noted otherwise, a bundle of the plurality of first order diffracted lights is treated as one diffracted light L2. A direction of the principal ray in the center of the diffracted lights L2 is a direction passing the center of the bundle of the plurality of first order diffracted lights and parallel to the principal rays of the first order diffracted lights.

The diffractive optical element 5 generates a diffracted light distribution in which a luminous intensity distribution is formed in a rectangular shape as a whole and an aspect ratio of the luminous intensity distribution coincides with an aspect ratio of an illumination target (an image forming region of the light modulating device). Consequently, it is possible to efficiently make illumination light formed in a rectangular shape as a whole incident on image forming regions of the light modulating devices 102R, 102G, and 102B formed in a rectangular shape.

In the diffractive optical element 5, it is preferable that the lights L1 are perpendicularly incident on an incident surface 5a of the diffractive optical element 5. The optical axis ax1 is orthogonal to the light incident surface 5a. Consequently, it is easy to perform diffractive optical design of the CGH for obtaining the diffracted lights L2. On the other hand, the direction of the principal ray in the center of the diffracted lights L2 is tilted with respect to the optical axis ax1 of the light L1 emitted from the array light source 2.

The superimposing optical system 6 is configured by two lenses, i.e., a superimposing lens 6a and a field lens 6b. The superimposing optical system 6 is arranged in a state in which an optical axis ax2 of the superimposing optical system 6 is set to coincide with the direction of the principal ray in the center of the diffracted lights L2.

It is preferable that the direction of the principal ray in the center of the diffracted lights L2 is tilted at an angle θ of 5 to 20° with respect to the optical axis ax1 of the lights L1 emitted from the array light source 2. Note that, in FIG. 2, the angle θ is represented as an angle on an acute angle side formed by the optical axis ax2 and the optical axis ax1. Consequently, the first order diffracted light having maximum diffraction efficiency among the diffracted lights L2 emitted from the diffractive optical element 5 efficiently enters the superimposing optical system 6.

The superimposing optical system 6 superimposes the diffracted lights L2 emitted from the diffractive optical element 5 on the illumination target, and the light modulating device 102R is irradiated with the superimposed lights L3 that serves as illumination light.

In a illumination device 1, the direction of the principal ray in the center of the diffracted lights L2 coincides with the optical axis ax2 of the superimposing optical system 6. Therefore, it is possible to emit illumination light having a more uniform illuminance distribution while reducing an aberration due to the superimposing optical system 6.

The arrangement of the diffractive optical element 5, the superimposing optical system 6, and the light modulating device 102R is explained with reference to FIGS. 3A to 3C. Note that FIG. 3A is an optical path diagram of first order diffracted lights emitted from an optical center of the diffractive optical element 5 and the periphery of the optical center S. FIG. 3B is an optical path diagram of parallel lights coming from the light modulating device 102R side. FIG. 3C is an optical path diagram of parallel lights coming from the diffractive optical element 5 side.

In the illumination device 1, as shown in FIG. 3B, the diffractive optical element 5 is arranged at a combined front focal position of a lens group including the lenses 6a and 6b. On the other hand, as shown in FIG. 3C, the image forming region of the light modulating device 102R serving as the illumination target is arranged at a combined rear focal position of the lens group including the lenses 6a and 6b. Consequently, as shown in FIG. 3A, it is possible to efficiently make the lights L3 superimposed by the superimposing optical system 6 incident on the image forming region of the light modulating device 102R.

The diffracted light L2 emitted from the diffractive optical element 5 is formed by a bundle of a plurality of first order diffracted lights. The first order diffracted lights form illumination light having a small aberration in the image forming region of the light modulating device 102R while being superimposed with one another by the superimposing optical system 6. Consequently, it is possible to emit illumination light having a more uniform illuminance distribution toward the image forming region of the light modulating device 102R.

In the illumination device 1 having the configuration explained above, by using the CGH as the diffractive optical element 5, it is possible to generate illumination lights having a more uniform illuminance distribution (brightness) while reducing an aberration due to the superimposing optical system 6. It is possible to efficiently emit such illumination lights toward the image forming region of the light modulating device 102R serving as the illumination target.

Therefore, it is possible to perform display excellent in image quality by applying the illumination devices 101R, 101G, and 101B to the projector 100.

In the projector 100, the lights L1 which are linearly polarized are emitted from the array light source 2. Therefore, it is possible to make the illumination lights emitted from the respective illumination devices 101R, 101G, and 101B respectively incident on the light modulating devices 102R, 102G, and 102B without using polarization conversion elements or the like. Consequently, it is possible to further reduce the size of the projector 100 while reducing the number of components.

In the projector 100, it is preferable that the array light source 2 and the diffractive optical element 5 are arranged such that, when the direction of the principal ray in the center of the diffracted lights L2 is set to coincide with the horizontal direction, the lights L1 emitted from the array light source 2 is incident on the diffractive optical element 5 from upward to downward.

The projector 100 projects, with tilted illumination, an image relatively bright on the downward side and relatively dark on the upward side is displayed on the screen SCR. On the other hand, the illumination devices 101R, 101G, and 101B irradiate the image forming regions of the light modulating devices 102R, 102G, and 102B with illumination lights relatively bright on the downward side and relatively dark on the upward side on.

In this case, the illumination lights is converted into image lights by passing through the light modulating devices 102R, 102G, and 102B. Further, the image lights are reversed vertically by the projection optical system 104. Consequently, the image lights become relatively bright on the upward side and relatively dark on the downward side on the screen SCR. Therefore, it is possible to cancel a vertical illuminance distribution which is caused by the tilted illumination. Therefore, the projector 100 can perform display more excellent in image quality.

Note that the invention is not always limited to the embodiments. Various changes can be made without departing from the spirit of the invention.

For example, in the embodiment, the array light source 2 in which the plurality of semiconductor lasers 2a are arrayed is explained as an example. However, the light sources included in the illumination device 1 are not limited to such a configuration and only have to be light sources that emit lights of linearly polarized coherent lights. The illumination device 1 may include only one light source.

In the embodiment, the projector 100 including the three light modulating devices 102R, 102G, and 102B is explained as an example. However, the invention can also be applied to a projector that displays a color video (image) with one light modulating device. Further, the light modulating device is not limited to the liquid crystal panel explained above. For example, a digital mirror device can also be used.

The entire disclosure of Japanese Patent Application No. 2013-053728, filed on May 15, 2013 is expressly incorporated by reference herein.

What is claimed is:

1. A illumination device comprising:
a light source;
a diffractive optical element on which light emitted from the light source is made incident; and
a superimposing optical system on which diffracted light emitted from the diffractive optical element is made incident, wherein
a direction of a principal ray in the center of the diffracted light coincides with an optical axis of the superimposing optical system.

2. The illumination device according to claim 1, wherein
the light emitted from the light source is perpendicularly made incident on a light incident surface of the diffractive optical element, and
the direction of the principal ray in the center of the diffracted light is tilted with respect to an optical axis of the light emitted from the light source.

3. The illumination device according to claim 2, wherein the direction of the principal ray in the center of the diffracted light is tilted at an angle of 5 to 20° with respect to the optical axis of the light emitted from the light source.

4. The illumination device according to claim 1, wherein
the superimposing optical system is configured by a lens group of at least two lenses,
the diffractive optical element is arranged at a combined front focal position of the lens group, and
an illumination target is arranged at a combined rear focal position of the lens group.

5. The illumination device according to claim 4, wherein the diffracted light has a luminous intensity distribution of a rectangular shape as a whole, an aspect ratio of the luminous intensity distribution being equal to an aspect ratio of the illumination target.

6. The illumination device according to claim 1, wherein the light source and the diffractive optical element are arranged such that, when the principal ray in the center of the diffracted light is set to coincide with the horizontal direction, the light emitted from the light source is made incident on the diffractive optical element from upward to downward.

7. The illumination device according to claim 1, wherein a computer generated hologram is used as the diffractive optical element.

8. The illumination device according to claim 1, wherein a semiconductor laser is used as the light source.

9. The illumination device according to claim 1, wherein an array light source in which a plurality of semiconductor lasers are arrayed is used as the light source.

10. The illumination device according to claim 1, further comprising a collimator optical system configured to convert the light emitted from the light source into parallel light.

11. The illumination device according to claim 1, wherein an afocal optical system is arranged between the light source and the diffractive optical element.

12. A projector comprising:
a illumination device configured to emit illumination light;
a light modulating device configured to form image light obtained by modulating the illumination light according to image information; and
a projection optical system configured to project the image light, wherein
the illumination device according to claim 1 is used as the illumination device.

13. A projector comprising:
a illumination device configured to emit illumination light;
a light modulating device configured to form image light obtained by modulating the illumination light according to image information; and
a projection optical system configured to project the image light, wherein
the illumination device according to claim 2 is used as the illumination device.

14. A projector comprising:
a illumination device configured to emit illumination light;
a light modulating device configured to form image light obtained by modulating the illumination light according to image information; and
a projection optical system configured to project the image light, wherein
the illumination device according to claim 3 is used as the illumination device.

15. A projector comprising:
a illumination device configured to emit illumination light;
a light modulating device configured to form image light obtained by modulating the illumination light according to image information; and
a projection optical system configured to project the image light, wherein
the illumination device according to claim 4 is used as the illumination device.

16. A projector comprising:
a illumination device configured to emit illumination light;
a light modulating device configured to form image light obtained by modulating the illumination light according to image information; and
a projection optical system configured to project the image light, wherein
the illumination device according to claim 5 is used as the illumination device.

17. A projector comprising:
a illumination device configured to emit illumination light;
a light modulating device configured to form image light obtained by modulating the illumination light according to image information; and
a projection optical system configured to project the image light, wherein
the illumination device according to claim 6 is used as the illumination device.

18. A projector comprising:
a illumination device configured to emit illumination light;
a light modulating device configured to form image light obtained by modulating the illumination light according to image information; and
a projection optical system configured to project the image light, wherein
the illumination device according to claim 7 is used as the illumination device.

19. The projector according to claim 12, wherein
the light emitted from the light source is linearly polarized light, and
a liquid crystal panel is used as the light modulating device.

20. The projector according to claim 12, wherein
a plurality of the illumination devices and a plurality of the light modulating devices are arranged for respective illumination lights having different wavelength regions, and
a combining optical system configured to combine image lights modulated for the respective illumination lights having the different wavelength regions is further provided.
